(19) United States
(12) Patent Application Publication
(10) Pub. No.: US 2013/0152905 A1
(43) Pub. Date: Jun. 20, 2013

(54) HYDROCARBON SENSOR FOR PURGING CANISTER OF EXTENDED RANGE ELECTRIC VEHICLE

(71) Applicant: Continental Automotive Systems, Inc., Auburn Hills, MI (US)

(72) Inventors: Brian G Woods, Chatham (CA); David W Balsdon, Chatham (CA)

(73) Assignee: CONTINENTAL AUTOMOTIVE SYSTEMS, INC., Auburn Hills, MI (US)

(21) Appl. No.: 13/714,560

(22) Filed: Dec. 14, 2012

Related U.S. Application Data
(60) Provisional application No. 61/577,196, filed on Dec. 19, 2011.

(51) Int. Cl. F02M 33/04

(52) U.S. Cl. CPC F02M 33/04; Y10S 903/904
USPC 123/520; 903/902

(57) ABSTRACT

An evaporative fuel vapor control system (10) for extended range electric vehicle includes a fuel supply (18) for storing fuel that generates fuel vapor, an internal combustion engine (16) supplied with fuel from the fuel supply, a vapor canister (20) in fluid communication with the fuel supply to retain fuel vapor and being in fluid communication with the engine, a hydrocarbon sensor (24) to determine when hydrocarbon saturation is occurring in the canister, a vapor control valve (22) associated with the vapor canister. A controller (26) is electrically connected with the hydrocarbon sensor and with the control valve such that when the controller receives a signal from the hydrocarbon sensor indicating that the engine should be started to purge the canister, the controller is constructed and arranged to cause the control valve to control a flow of fuel vapor from the purge passage while the engine is operating.

### FIELD

This invention relates to purging a vapor canister of a vehicle and, more particularly, to a hydrocarbon sensor for indication when a vapor canister of an extended range electric vehicle should be purged.

### BACKGROUND

Conventional gasoline engines of automobiles not only emit pollutant emissions via combustion of fuel or via emission of lubricant or fuel in the crankcase, the engines also produces hydrocarbon emissions via evaporation of fuel stored in the automobile. To reduce or eliminate this form of emission, modern automobiles store the fuel vapor in a canister and control its release from the canister into the combustion chamber for combustion. Such on-board evaporative emission control system (EVAP) typically includes a charcoal type vapor canister that collects vapor emitted from a fuel tank and a vapor control valve that regulates the amount of vapor permitted to be released from the canister to the engine. The canister is purged continuously when he engine is operating. To manage the air/fuel ratio, vehicles currently use an oxygen sensor to monitor the change in the oxygen content in the exhaust purge flow. The oxygen is assumed to be reacted with the EVAP hydrocarbons, so when the flows are known, the engine controller will calculate the amount of hydrocarbon from the EVAP line that the flow just went through.

With the extended range electric vehicle (EREV), for example, plug in hybrid vehicles such as the Chevy Volt, the gasoline engine may never come on if the battery charge to the electric motor never gets low enough to initiate the operation of the engine. The vehicle therefore, must start the engine periodically to purge the canister, based on just an estimate as to when the canister is full. Some of these vehicles use high pressure tanks (up to 5 psi) to reduce the amount of vapors produced, but this still doesn't indicate when the canister is full, since the canister just fills up more slowly. On an extended range electric EREV, avoiding the use of the gasoline engine will increase the overall mileage, therefore it is desirable to not start the engine if it is not needed.

Thus, there is a need to provide a hydrocarbon sensor in an EREV that will tell the engine control unit (ECU) when the canister needs purging so that the engine is only started when it is needed.

### SUMMARY OF THE INVENTION

An object of the invention is to fulfill the need referred to above. In accordance with the principles of the present invention, this objective is achieved by providing an evaporative fuel vapor control system for extended range electric vehicle (EREV). The system includes a fuel supply for storing fuel that generates fuel vapor in the fuel supply, an internal combustion engine constructed and arranged to be supplied with fuel from the fuel supply, a vapor canister having a vapor passage disposed in fluid communication with the fuel supply to retain fuel vapor from the fuel supply and having a purge passage in fluid communication with the engine, a hydrocarbon sensor constructed and arranged to determine when hydrocarbon saturation is occurring in the canister, a vapor control valve disposed in the purge passage between the engine and the vapor canister, and a controller electrically connected with the hydrocarbon sensor and with the control valve such that when the controller receives a signal from the hydrocarbon sensor indicating that the engine should be started to purge the canister, the controller is constructed and arranged to cause the control valve to control a flow of fuel vapor from the purge passage while the engine is operating.

In accordance with another aspect of an embodiment, a method is provided for purging hydrocarbons from a vapor canister of an extended range electric vehicle (EREV). The method provides an (EREV) having an electric motor and an internal combustion engine. The electric motor is constructed and arranged to power the vehicle and the engine is constructed and arranged to power the vehicle when a battery charge of the electric motor is not sufficient for powering the vehicle. A fuel supply is provided for storing fuel that generates fuel vapor in the fuel supply and the fuel supply supplies fuel to the engine. A vapor canister has a vapor passage disposed in fluid communication with the fuel supply to retain fuel vapor from the fuel supply and having a purge passage in fluid communication with the engine. A hydrocarbon sensor determines when hydrocarbon saturation is occurring in the canister. While the electric motor is powering the vehicle, the engine is started when hydrocarbon saturation in the canister is determined to be occurring. While the engine is operating, hydrocarbons are purged from the vapor canister via the purge passage.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic diagram of an evaporative fuel vapor control system for an EREV, in accordance with and embodiment.

FIG. 2 is a view of a hydrocarbon sensor of the control system of FIG. 1, coupled with a passage.

FIG. 3 shows the signal runtime between a transmitted signal and a received signal of the hydrocarbon sensor.

### DETAILED DESCRIPTION OF EXEMPLARY EMBODIMENTS

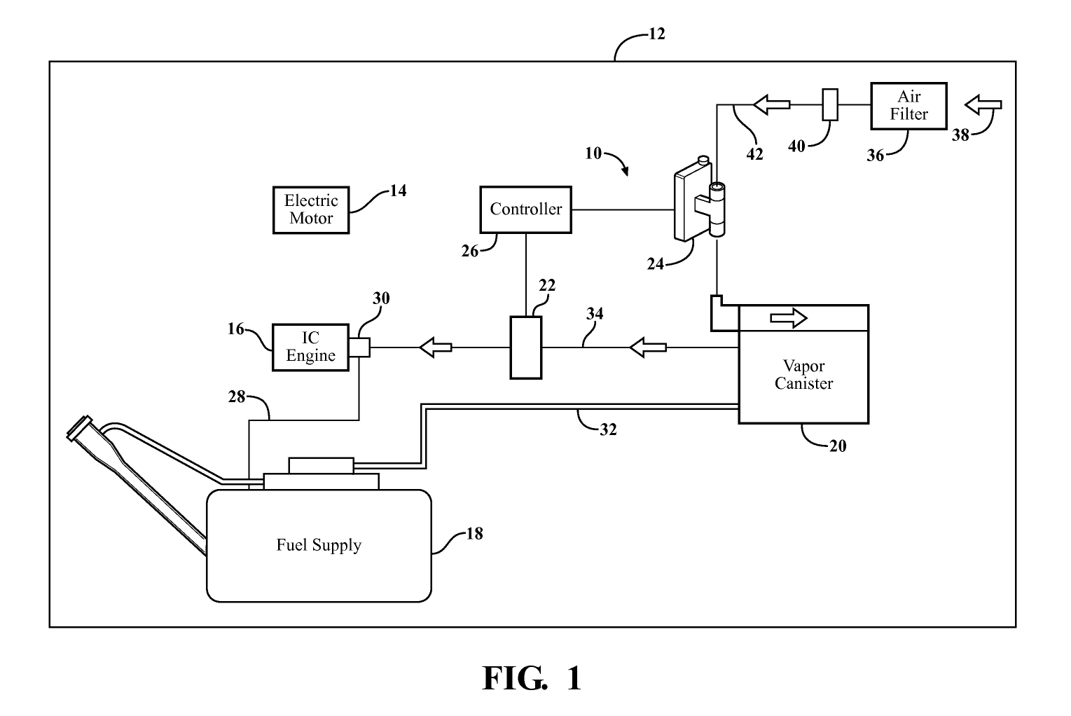

Referring to FIG. 1, an evaporative fuel vapor control system, generally indicated at 10, for an EREV 12 is shown. The vehicle 12 includes an electric motor 14 and an internal combustion (IC) engine 16. The vehicle is configured operate on power provided by the electric motor 14. However, when the charge of the batteries supplying the electric motor 14 becomes low, the IC engine 16 will operate to power the vehicle and charge the batteries.

The system 10 includes a fuel supply 18, a vapor canister 20, a vapor control or purge valve 22, a hydrocarbon sensor 24 and a controller such as an engine control unit (ECU) 26. The fuel supply 18 can be a suitable fuel tank that stores fuel and vapors formed or generated in the fuel tank. The IC engine 16 can be supplied with fuel from the fuel supply 18 via suitable fuel supply conduits 28 to an intake manifold 30 for injection into the engine 16. Outlets of fuel injectors (not shown) are mounted in the intake manifold 30 to dispense fuel into the intake manifold 30. Alternatively, high-pressure, direct injection fuel injectors can be mounted directly to the cylinder head of the engine 16 in pressure direct injection applications.

The vapor canister 20 includes a vapor passage 32 disposed in fluid communication with the fuel supply 18 to retain fuel vapor from the fuel supply 18. The vapor canister 20 includes a purge passage 34 disposed in fluid communication with the intake manifold 30 to release fuel vapor to the engine 16 via the purge valve 22. It can be appreciated that instead of the purge passage 34 being in communication with the intake manifold 30, the purge passage 34 can be in communication with the exhaust manifold (not shown) of the engine 16. An air filter 36 filters fresh air entering from inlet 38 and, when vent valve 40 is opened, the filtered air replaces the volume of fuel vapor being purged into the engine 16. The arrows in FIG. 1 show the air/vapor flow during purging of the canister 20. The purge valve 22 is disposed in the purge passage 34 between the engine 16 and the vapor canister 20. Preferably, the vapor canister 20 is a charcoal type canister.

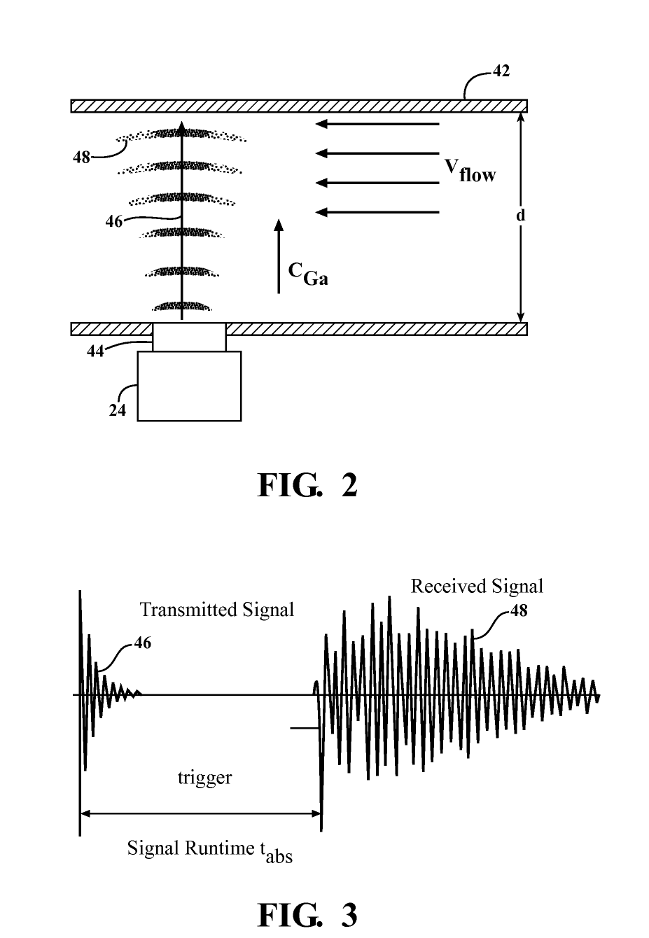

The hydrocarbon sensor 24, preferably provided in a passage 42 between the inlet 38 and the canister 20, detects a level of hydrocarbons in the canister 20. In particular, the sensor 24 detects when hydrocarbons just start to blow through the canister 20, which occurs when the canister 20 is saturated with hydrocarbons. Alternatively, the sensor 24 can be provided in a duct of the canister 20, or in the in the purge passage 34. With reference to FIG. 2, the sensor 24 preferably uses ultrasonic sensing technology and has a transducer 44 that is integrated in the tubular passage 42. The transducer 44 produces an ultrasonic signal 46 that is reflected by the wall of the passage 42. The reflected signal 48 is in the range of about 1 mV in amplitude. The transducer 44 works as a transmitter and receiver.

The speed of sound depends on temperature and air/gasoline ratio. A signal after-treatment of the transducer 44 measures the runtime of the reflected, acoustic wave signal 48 (FIG. 3). Since the speed of sound decrease with increasing concentration of hydrocarbons, the main compounds being Butane, Pentane and Hexane, the sound wave signal 48 will move more slowly in a canister saturated with hydrocarbons than in a hydrocarbon-free canister. The temperature effects of the runtime of the wave 48 are compensated and after recording, the concentration of hydrocarbons is calculated and applied as a linear concentration signal at the output of the sensor 24, based on:

C_{gas mixture}=2d/t_{abs}
where c is the concentration of hydrocarbons, d is the diameter of the passage 42, and t is the signal runtime.

The sensor 24 and the purge valve 22 are electrically connected with the controller 26. On an extended range electric EREV, avoiding the use of the gasoline engine will increase the overall mileage, therefore it is desirable to not start the engine if it is not needed. With this in mind, the hydrocarbon sensor 24 will signal the controller 26 indicating that the engine 16 should be started to purge the canister 20. Once the engine 16 is started, the controller 26 opens the purge valve 22 so that the canister 20 can be purged. Thus, when the electric motor 14 is operating, the engine 16 is started when it is actually needed to purge the canister 20, instead of being periodically started as is conventionally done.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. An evaporative fuel vapor control system for extended range electric vehicle (EREV), the system comprising:
a fuel supply for storing fuel that generates fuel vapor in the fuel supply,
an internal combustion engine constructed and arranged to be supplied with fuel from the fuel supply,
a vapor canister having a vapor passage disposed in fluid communication with the fuel supply to retain fuel vapor from the fuel supply and having a purge passage in fluid communication with the engine,
a hydrocarbon sensor constructed and arranged to determine when hydrocarbon saturation is occurring in the canister,
a vapor control valve disposed in the purge passage between the engine and the vapor canister, and
a controller electrically connected with the hydrocarbon sensor and with the control valve such that when the controller receives a signal from the hydrocarbon sensor indicating that the engine should be started to purge the canister, the controller is constructed and arranged to cause the control valve to control a flow of fuel vapor from the purge passage while the engine is operating.

2. The system of claim 1, wherein the hydrocarbon sensor is associated with a passage connected with the vapor canister.

3. The system of claim 2, wherein the hydrocarbon sensor is an ultrasonic sensor.

4. The system of claim 3, wherein the hydrocarbon sensor includes a transducer constructed and arranged to provide an ultrasonic signal in the passage and to monitor a runtime of an acoustic wave signal generated by the ultrasonic signal and reflected by the passage.

5. The system of claim 4, wherein the wave signal is constructed and arranged to be about 1 mV in amplitude.

6. The system of claim 1, wherein the controller is an engine control unit of the vehicle.

7. The system of claim 1, in combination with the EREV, wherein the EREV has an electric motor for powering the vehicle, the electric motor being constructed and arranged to remain operating while the engine is operating to purge the canister.

8. A method of purging hydrocarbons from a vapor canister of an extended range electric vehicle (EREV), the method comprising:
providing an (EREV) having an electric motor and an internal combustion engine, the electric motor being constructed and arranged to power the vehicle and the engine being constructed and arranged to power the vehicle when a battery charge of the electric motor is not sufficient for powering the vehicle,
providing a fuel supply for storing fuel that generates fuel vapor in the fuel supply, the fuel supply supplying fuel to the engine,
providing a vapor canister having a vapor passage disposed in fluid communication with the fuel supply to retain fuel vapor from the fuel supply and having a purge passage in fluid communication with the engine;
determining, with a hydrocarbon sensor, when hydrocarbon saturation is occurring in the canister,
while the electric motor is powering the vehicle, starting the engine when hydrocarbon saturation in the canister is determined to be occurring, and
while the engine is operating, purging hydrocarbons from the vapor canister via the purge passage.

9. The method of claim 8, wherein the determining step includes:
providing an ultrasonic signal in a passage associated with the vapor canister, and
monitoring a runtime of an acoustic wave signal generated by the ultrasonic signal and reflected by the passage.

10. The method of claim 9, wherein a concentration of hydrocarbons in the vapor canister is determined by c_{gas mixture}=2d/t_{abs}
where c is the concentration of hydrocarbons in the canister, d is a diameter of the passage, and t is the runtime of the wave signal.
